(19) United States
(12) Patent Application Publication
(10) Pub. No.: US 2014/0136395 A1
(43) Pub. Date: May 15, 2014

(54) METHOD AND SYSTEM FOR AN INTERFACE BETWEEN FIXED INCOME ALTERNATIVE TRADING SYSTEMS

(71) Applicant: Tim Dowling, Rye, NY (US)

(72) Inventor: Tim Dowling, Rye, NY (US)

(21) Appl. No.: 14/232,612

(22) PCT Filed: Jul. 13, 2012
(86) PCT No.: PCT/US2012/046807

§ 371 Date: Jan. 13, 2014

Related U.S. Application Data
(60) Provisional application No. 61/457,939, filed on Jul. 13, 2011.

(51) Int. Cl. G06Q 40/04

(52) U.S. Cl. CPC G06Q 40/04
USPC 705/37

(57) ABSTRACT

The present invention includes a rules-based system for matching and executing qualifying fixed income securities or corporate bonds between a system for matching retail trading orders (Retail Alternative Trading System or “Retail ATS”) and another system for matching institutional trading orders (Institutional Alternative Trading System, or “Institutional ATS”) to form a single combined system.

### RELATED APPLICATIONS

This application claims priority to U.S. Provisional Application No. 61/457,939 which was filed on Jul. 13, 2011 and which is herein incorporated in its entirety by reference.

### TECHNICAL FIELD OF THE INVENTION

The present invention relates generally to an electronic bond trading system and, more specifically, to a rules-based system for matching and executing qualifying orders between a system for matching retail trading orders (“Retail Alternative Trading System,” or “Retail ATS”) and another system for matching institutional trading orders (“Institutional Alternative Trading System,” or “Institutional ATS”).

### BACKGROUND OF THE INVENTION

In recent years, electronic trading systems have gained widespread acceptance for trading a wide variety of financial products. Retail fixed income investors, such as individuals, typically buy bonds through their brokerage accounts in relatively small quantities, such as $10,000 to $500,000. Electronic trading systems such as BondDesk and Knight Bondpoint have been developed to provide these investors with bids and offers from multiple brokers. Retail ATSs are “Limited Order Book” driven, which means orders are received and then recorded on a Book and prioritized by price, just like the Specialist's Order Book for stocks traded on the New York Stock Exchange (“NYSE”).

Institutional investors, such as mutual and pension funds, typically buy bonds from a variety of brokerage firms; Alternative Trading Systems (“ATSs”) have emerged in some asset categories for these investors but not in others. Although institutional and retail investors invest in many of the same securities, institutional investors frequently seek to buy or sell large quantities of bonds, much larger on average than the typical trade for a retail investor. Institutional investors would not be well served by placing their larger orders to buy and sell on Retail ATSs, due to the significant quantity discrepancy. Further, institutional investors, as they may own significant percentages of individual bond issues, are sensitive to having their desire to buy or sell a particular issue inadvertently broadcasted to the investing public. A good electronic trading mechanism does not exist for the Institutional Market.

Many of these electronic trading systems use a bid/offer process to which bids and offers for specified quantities of bonds at specified prices are submitted. If the bid price exceeds the offer price by a specified amount for an acceptable quantity (a “Marketable Order”), a trade is executed by the processor, and the buyer and seller are notified of the details to enable settlement. If the bid does not exceed the offer by the specified amount, or the quantity was not acceptable (a “Non-marketable Order”), the order is added to the order book and will be executed if an offsetting “Marketable” order is entered into the system. Additionally, if the offer price of an Order is revised to be below the bid price by the specified amount, that Order will become Marketable and be executed.

As described above, institutions typically trade larger quantities than retail investors; additionally, the trading “protocols” for institutional investors, who typically interact with brokers on the telephone or through email, are different than the protocols for retail investors who trade on ATSs such as BondDesk or BondPoint. Institutional investors will specify the price at which they will bid or offer a bond; retail bond investors on an ATS are not always allowed to specify their price, but may be allowed by their brokerage firm only to choose to execute at a bid or offer price displayed by a broker.

There are further differences between retail and institutional bond trading. Retail bond investors also may be limited by their brokerage firm on which issues they may buy, due to suitability concerns; institutional investors are assumed to be sophisticated, and don't receive the same degree of oversight by brokerage firm. Institutional investors typically buy and sell bonds at prices which include a built-in fee for the dealer (“spread”) on transactions conducted as riskless principal, which means that the dealer is passing customer transactions through its account without ever having a long or short position; if the dealer's inventory is used as risk principal, which means that the dealer is buying and selling bonds out of its own account and is taking long or short positions, there may not be an identifiable spread. Retail investors compensate the dealers in a variety of fashions, including spread, a quantity-based commission or a trade-based ticket charge. Additionally, retail investors are generally limited to purchasing registered securities, whereas most institutions qualify to buy 144a private placements.

### SUMMARY OF THE INVENTION

There is a need for an exchange-like electronic bond trading venue, which is useful to Retail ATS operators, individuals, institutional bond dealers and institutions by combining retail and institutional order flow while respecting the regulatory and business requirements of all involved parties. A venue that facilitates transactions between the institutional and retail trading communities will also increase trade volumes and decrease transaction costs. Further, there is a need for an electronic venue with set spread compensation for the dealer, which offers the possibility of price improvement to buyers and sellers.

Currently, some retail ATSs have attempted to attract institutional flow, but not in an appropriate manner that would be attractive to major institutional fixed income investors. There are institutional auction venues, such as MarketAxess, operating on a “Request For Quote” or auction basis, but this methodology reveals participant details and is not exchange-like.

One embodiment of the invention is an electronic bond order book ATS for institutions, operated as part of a broker/dealer, which allows participating institutions to enter buy and sell orders by Committee on Uniform Securities Identification Procedures (“CUSIP”) Number (a unique nine-character security identifier published by CUSIP Global Services) through an electronic interface either on a displayed (“Lit”) or undisplayed (“Dark”) basis. “Marketable” orders, those in which the bid exceeds the offer by a specified amount, are executed immediately. The specified amount is retained by the broker as the fee for the service; if the bid exceeds the offer by more than the specified amount, the excess could be split by the buyer and the seller or be used to reduce the price to one party, depending on the rules set by the ATS. “Nearly marketable” orders, those in which the bid is lower than the offer but within a specified range, may produce an e-mail notification to both buyer and seller offering a “split the difference” execution, less the specified fee amount. If both agree within the specified time, the trade is executed; otherwise, both orders remain active on the order book for that security. Trades are executed on a riskless principal basis, in which the customer's trade is processed by the dealer through its trading account with a spread between the buy and sell price being retained by the dealer, or on an agency basis, in which the dealer processes the trade through the customer's account and a visible commission is shown on the confirmation, basis by the dealer.

Another embodiment of the invention pertains to how an Institutional ATS interacts with a Retail ATS, if both ATSs were under common ownership or operated in a coordinated fashion by a joint venture. A processor constructs a combined order book by CUSIP from both the retail and institutional ATSs; the processor then automatically instructs the Retail ATS and/or Institutional ATS to execute qualifying trades on a within-channel (trades conducted between a Retail Buyer and Retail Seller, or an Institutional Buyer and Institutional Seller) or cross-channel (a trade between a Retail Buyer and Institutional Seller, or Retail Seller and Institutional Buyer) basis. Preferably, the Institutional ATS and Retail ATS are operated by SEC-regulated broker/dealers; the interfacing order book invention would not necessarily need to be operated by a broker/dealer, and would not execute trades itself or have its own clients. Qualifying trades are those trades which conform to pre-coded institutional client guidelines and the stated protocols of both the retail and institutional ATSs, such as minimum order quantities and minimum execution quantities; “if then” logic will be applied by the processor to all proposed trades to determine which ones qualify. The processor will calculate the “compensation-inclusive price” for buy and sell orders, then execute trades at prices at or better than the price specified by the order, or the processor could execute trades at clearing price and compensation paid separately. Cross-channel trades will be executed by the dealer operator of the Institutional ATS buying or selling to the dealer operator of the Retail ATS at the compensation-inclusive price or clearing price.

Another embodiment of the invention is a “two track quote” price quotation displaying the best bid and offer for the retail and institutional pools separately. There's a need for more detail on the depth of the market to attract institutional order flow than is described by the more typical best bid and offer display, which show the best prices for very small bids and offers, and are impractical for large institutional trading. The presence of Dark orders on the institutional track will be made known by a symbol.

In another embodiment, the invention allows institutions to set and store their trade preferences on the Institutional ATS processor, which will then be applied to each specific transaction that they submit. Such preference options may include maximum quantity orders, minimum quantity trades, acceptable lot quantities (must be divisible by $100,000, for example) and directions on whether to optimize price or quantity in certain circumstances. Further preference options will be designed to avoid “fat finger” trade errors.

In still another embodiment of the invention, a notification system alerts selected market participants of “crossed markets,” when, for any security, a bid is posted in the order book at a price higher than the offer leading to potential “arbitrage” trades.

In another embodiment, the invention includes a computer program product for financial trading, tangibly embodied in a computer readable storage device, the computer program product including instructions operable to cause a data processing apparatus to: receive at least one retail order from a first remote computing device associated with a retail client; receive at least one institutional order from a second remote computing device associated with an institutional client; create a Limit Order Book in which a first record of the Limit Order Book contains information pertaining to said at least one retail order and a second record of the Limit Order Book contains information pertaining to the at least one institutional order; organize records contained within the Limit Order Book into one of either buy order records or sell order records; prioritize the sell order records by information contained within the sell order records; use the prioritize sell order records to determine a first sell order record to examine; compare information contained in the first sell order record with information contained within a selected buy order record to determine if the selected buy order record may be partially fulfilled by the first sell order record; and execute the selected buy order record against the first sell order record.

In yet another embodiment, the invention includes a computer program product for financial trading, tangibly embodied in a computer readable storage device, the computer program product including instructions operable to cause a data processing apparatus to: receive at least one retail order from a first remote computing device associated with a retail client; receive at least one institutional order from a second remote computing device associated with an institutional client; create a Limit Order Book in which a first record of the Limit Order Book contains information pertaining to the at least one retail order and a second record of the Limit Order Book contains information pertaining to the at least one institutional order; organize records contained within the Limit Order Book into one of either buy order records or sell order records; prioritize the sell order records by information contained within the sell order records; use the prioritize sell order records to determine a first sell order record to examine; compare information contained in the first sell order record with information contained within a selected buy order record to determine if the selected buy order record may be partially fulfilled by said first sell order record; and execute the selected buy order record against the first sell order record.

In another embodiment, the invention is a combined Alternative Trading System, comprising: means for receiving at least one retail order from a first remote computing device associated with a retail client; means for receiving at least one institutional order from a second remote computing device associated with an institutional client; means for creating a Limit Order Book in which a first record of said Limit Order Book contains information pertaining to the at least one retail order and a second record of said Limit Order Book contains information pertaining to the at least one institutional order; means for organizing records contained within the Limit Order Book into one of either buy order records or sell order records; means for prioritizing the buy order records by information contained within the buy order records; means to use the prioritize buy order records to determine a first buy order record to examine; means to compare information contained in the first buy order record with information contained within a selected sell order record to determine if the selected sell order record may be partially fulfilled by the first buy order record; and means to execute the selected sell order record against the first buy order record.

Another embodiment of the invention is a method for matching information contained in buy orders received with information contained in sell orders received, comprising: receiving at least one retail order from a first remote computing device associated with a retail client; receiving at least one institutional order from a second remote computing device associated with an institutional client; creating a Limit Order Book in which a first record of the Limit Order Book contains information pertaining to the at least one retail order and a second record of the Limit Order Book contains information pertaining to the at least one institutional order; organizing records contained within the Limit Order Book into one of either buy order records or sell order records; prioritizing the sell order records by information contained within the sell order records; using the prioritize sell order records to determine a first sell order record to examine; comparing information contained in the first sell order record with information contained within a selected buy order record to determine if the selected buy order record may be partially fulfilled by the first sell order record; and executing the selected buy order against the first sell order.

Another embodiment of the invention is a method for matching information contained in buy orders received with information contained in sell orders received, comprising: receiving at least one retail order from a first remote computing device associated with a retail client; receiving at least one institutional order from a second remote computing device associated with an institutional client; creating a Limit Order Book in which a first record of said Limit Order Book contains information pertaining to the at least one retail order and a second record of the Limit Order Book contains information pertaining to the at least one institutional order; organizing records contained within the Limit Order Book into one of either buy order records or sell order records; prioritizing the buy order records by information contained within the buy order records; using the prioritize buy order records to determine a first buy order record to examine; comparing information contained in the first buy order record with information contained within a selected sell order record to determine if the selected sell order record may be partially fulfilled by the first buy order record; and executing said selected sell order against said first buy order.

Each of these embodiments may include: at least one institutional order includes information indicating if the institutional order is a lit order or a dark order; the sell order records are prioritized by price; the sell order records are prioritized by quantity; the information compared includes at least one of price, quantity, minimum order, increment, and execution type; or the selected buy order record is completely fulfilled by the first sell order record.

### BRIEF DESCRIPTION OF THE DRAWINGS

In the drawings, like reference characters generally refer to the same parts throughout the different views. The drawings are not necessarily to scale, rather emphasis is generally being placed upon illustrating the principles of various embodiments. The foregoing and other aspects of the invention will be better understood from the following description of embodiments of the invention, by way of example only, and with reference to the accompanying drawings, in which:

FIG. 1 shows the architecture for system that includes a Combined ATS 100 that is configured to handle both Retail ATS and Institutional ATS;

FIG. 2 illustrates the order flow 200 from Institutional Client Order to Institutional Dealer ATS prior to the information being sent to the ATS Interface 135;

FIG. 3 illustrates the order flow 300 from a Retail Client Order to Retail ATS prior to the information being sent to the ATS Interface 135;

FIG. 4 illustrates the order flow 400 from limit orders display for retail ATS “liquidity provider” broker/dealer workstation prior to the information being sent to the ATS Interface 135;

FIG. 5 illustrates the order flow 500 from retail ATS limit Order Book and Institutional ATS Limited Order Book where the displays are combined and cross-channel trading is enabled by the ATS Interface 135 within Combined ATS 100;

FIG. 6 illustrates a Two Track Quote 600 which includes information for dissemination to retail and Institutional channels within Combined ATS 100;

FIG. 7 illustrates an Internal Limited Order Book 700 for a “dark” order where the functionality is only available on the Institutional ATS within Combined ATS 100;

FIG. 8 illustrates an internal limit order book 800 for ATS Interface within the Combined ATS 100;

FIGS. 9A-B illustrates order flow of how the ATS Interface Directs trading within and between retail and institutional ASTs within Combined ATS 100;

FIG. 10 illustrates the iterative process involved in bond trading between various buyers and sellers using the Combined ATS 100;

FIG. 11A illustrates the Combined Limit Order Book after the transaction example in FIG. 10;

FIG. 11B is the “Two Track Quote” for retail and institutional dissemination for FIG. 11A;

FIG. 12 shows a flow chart 1200 for the decision flow on whether to execute a trade for the Combine ATS 100; and

FIG. 13 shows one embodiment of system including a Combined ATS.

### DETAILED DESCRIPTION OF THE INVENTION

In the following detailed description, reference will be made in detail to the preferred embodiments of the present invention, examples of which are illustrated in the accompanying drawings, which form a part hereof and show, by way of illustration, embodiments in which the invention may be practiced. These embodiments are described in sufficient detail to enable those skilled in the art to practice the invention, and it is to be understood that other embodiments may be utilized, and that structural, and logical changes may be made without departing from the spirit and scope of the present invention. The progression of processing steps described is exemplary of embodiments of the invention; however, the sequence of steps is not limited to that set forth herein and may be changed as is known in the art, with the exception of steps necessarily occurring in a certain order.

One of the purposes of the disclosed invention is to jumpstart electronic trading of corporate bonds by institutions by using the smaller trade size Retail ATS orders, just like how a starter motor gets a car engine going. An Institutional ATS, operating on Limit Order Book logic, is the right solution.

Bond trading is a heavily regulated and competitive environment. Broker/dealers will be both required by the regulators to “know their customer” and loathe to give customer flows over to a competitor. For those reasons, and because the retail and institutional markets have different trading “protocols” (the institutional market is always Firm, which means an order that is in the Limit Order Book is always executable, and retail is sometimes Subject, which means the party posting the order needs to provide approval before execution and transaction size expectations, a single (totally combined retail and institutional) ATS is not practicable. Certain bonds have been listed for trading on the NYSE in a Limit Order Book format for many years, and this platform has generated minimal volume.

However, an Interface which displays the order books from both the retail and institutional ATSs, and allows for trades that qualify (price, transaction size and protocol) to transact from one ATS to the other is possible and desirable. That Interface, which would direct trade executions within and between the dealers operating both retail and institutional ATSs is desirable, useful, and novel. Upon entry of an order onto either the Retail or the Institutional ATS, the Interface would logically iterate to find the best trade solution either within the Retail or Institutional ATSs, or between them. The best trade solution for an order could be constructed from orders on the retail ATS, institutional ATS or both ATSs. All trades executed by the ATS Interface would be executed “broker to broker”, and the interface itself would not need to have any customers (broker/dealers are not customers).

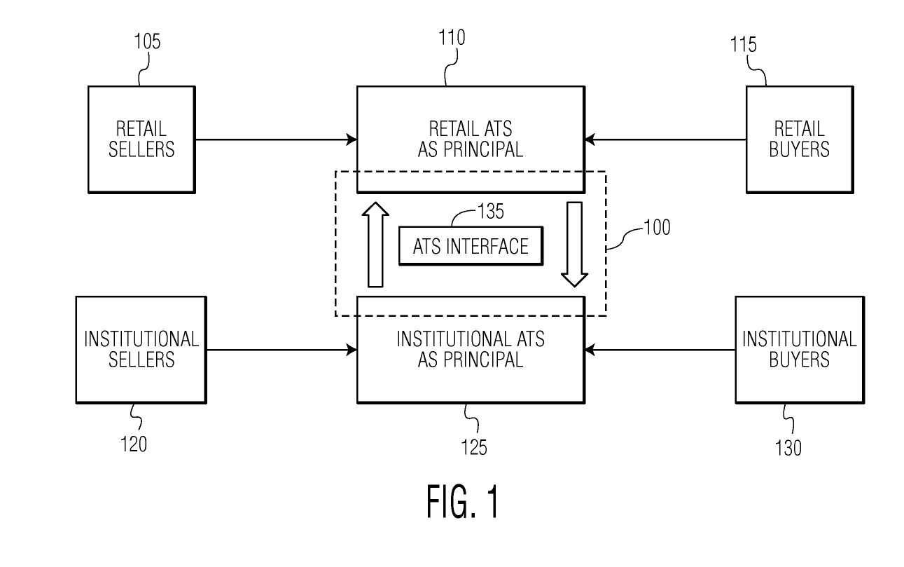

FIG. 1 shows the architecture for system that includes a Combined ATS 100 that is configured to handle both Retail ATS and Institutional ATS. The upper portion of FIG. 1 handles the Retail ATS and includes Retail Sellers 105, Retail ATS As Principal 110, and Retail Buyers 115. “As Principal” means that the dealer buys or sells bonds using its own house account, and not the customer's account at the dealer. The lower portion of FIG. 1 handles the Institutional ATS and includes Institutional Sellers 120, Institutional ATS As Principal 125 and Institutional Buyers 130. Located in between Retail ATS As Principal 110 and Institutional ATS As Principal 125 is the ATS Interface 135. The ATS Interface 135 serves to coordinate transactions between the Retail ATS and the Institutional ATS. In the combined system, the Retail Sellers 105 and Retail Buyers 115 of the existing Retail ATS remain clients of the Retail ATS, but benefit from the greater transaction opportunities provided by the ability to access the institutional order flow from Institutional Sellers 120 and Institutional Buyers 130. This is accomplished by the ATS Interface 135 being an iterative interface between the Retail ATS as Principal 110 and the Institutional ATS as Principal 125. Clients are designated as “Retail” or “Institutional” by the order channel from which their business is conducted. The ATS Interface 135 facilitates cross-channel transactions while respecting the procedures of each channel. The Combined ATS system 100 is shown as including the ATS Interface 135 and portions of both the Retail ATS as Principal 110 and Institutional ATS as Principal 125.

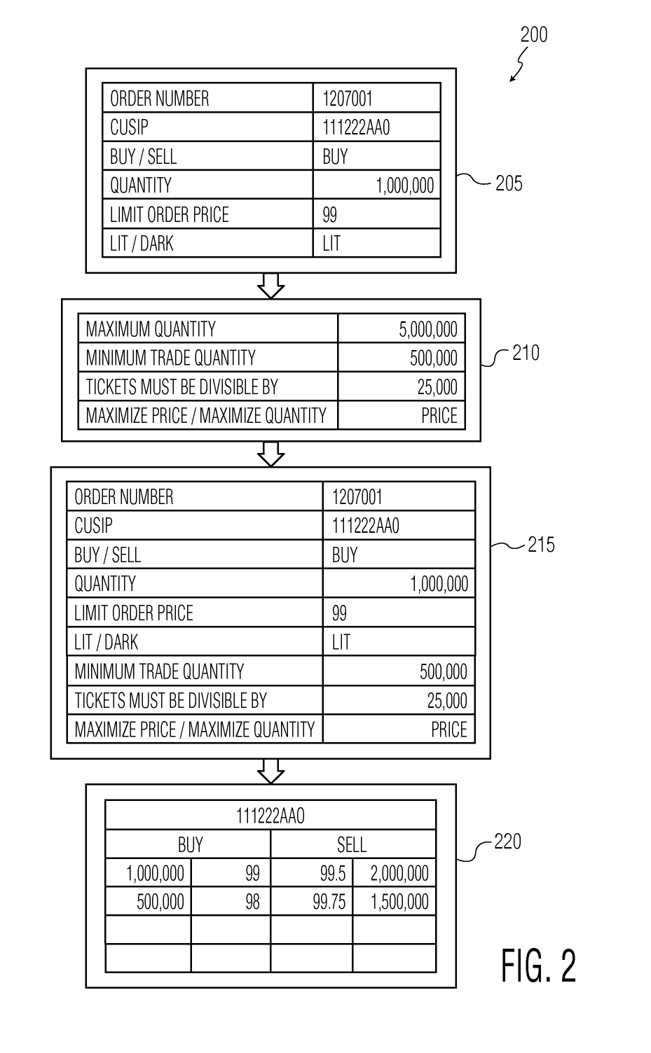

FIG. 2 illustrates the order flow 200 from Institutional Client Order to Institutional Dealer ATS prior to the information being sent to the ATS Interface 135. Institutional Client (Buyer 130) transmits an Order Ticket 205 which includes the Order Number (#1207001), CUSIP Number (11122AAO), a Buy/Sell Indicator (Buy), Quantity (1,000,000 bonds), an authorized Order Price (99) and a Lit/Dark Indicator. The authorized Order Price is a “not to exceed” price. The Lit/Dark Indicator is used to determine if information regarding this transaction is to be publically available or not. The Order Ticket 205 may be sent to the Institutional Dealer through either direct entry on a password protected website, from an Order Management System in XML format or from any other secure communications.

Order #1207001 is received by Institutional Dealer's ATS and the Pre-coded Institutional Client Trade Preferences 210 are added to the order. Example Pre-coded Institutional Client Trade Preferences may include the Maximum Quantity (5,000,000); the Minimum Trade Quantity (500,000); the Tickets Must Be Divisible By number (25,000) and an indicator as to whether price or quantity should be maximized (Maximize Price/Maximize Quantity). Additional Pre-coded Institutional Client Trade Preferences may also be included. In this case, price is being maximized.

Once the information from the Pre-coded Institutional Client Trade Preference is added a Transaction Order Ticket 215 is created. Transaction Order Ticket #1207001 is entered into Institutional Dealer's ATS in Limit Order Book for CUSIP #111222AAO.

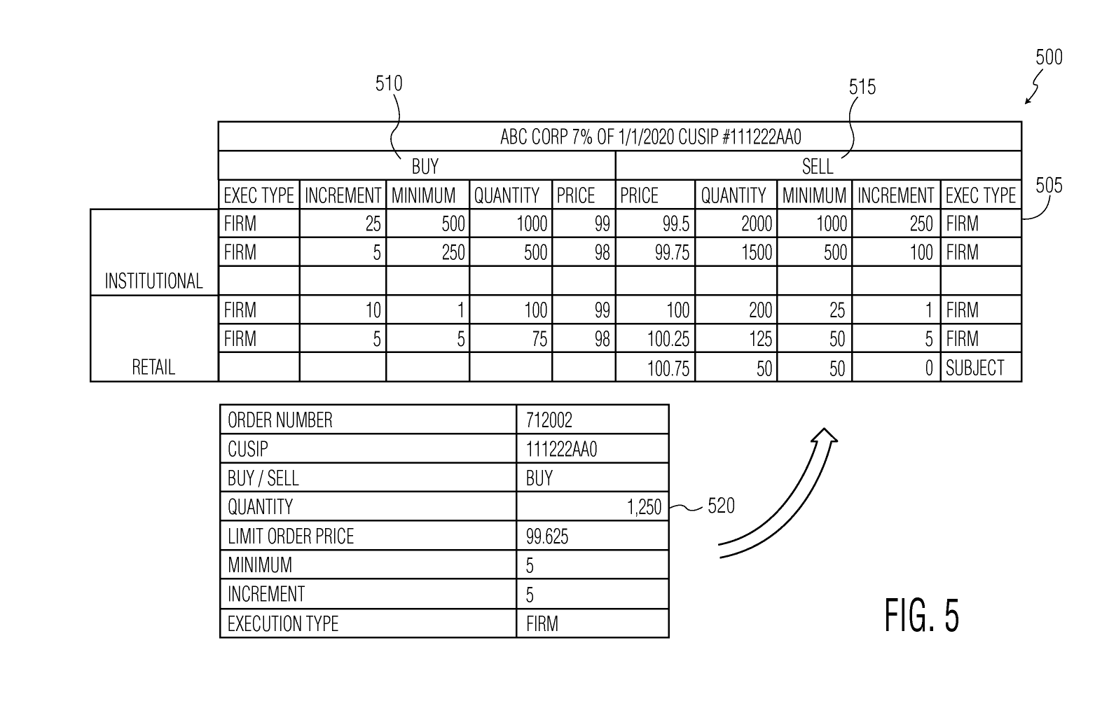

The Institutional Dealer's ATS now electronically displays updated Limit Order Book 220 for CUSIP 111222AAO. All the orders posted on Limit Order Book 220 for CUSIP #111222AAO are simultaneously transmitted to the ATS Interface and posted on the Combined Limit Order Book 505 (FIG. 5).

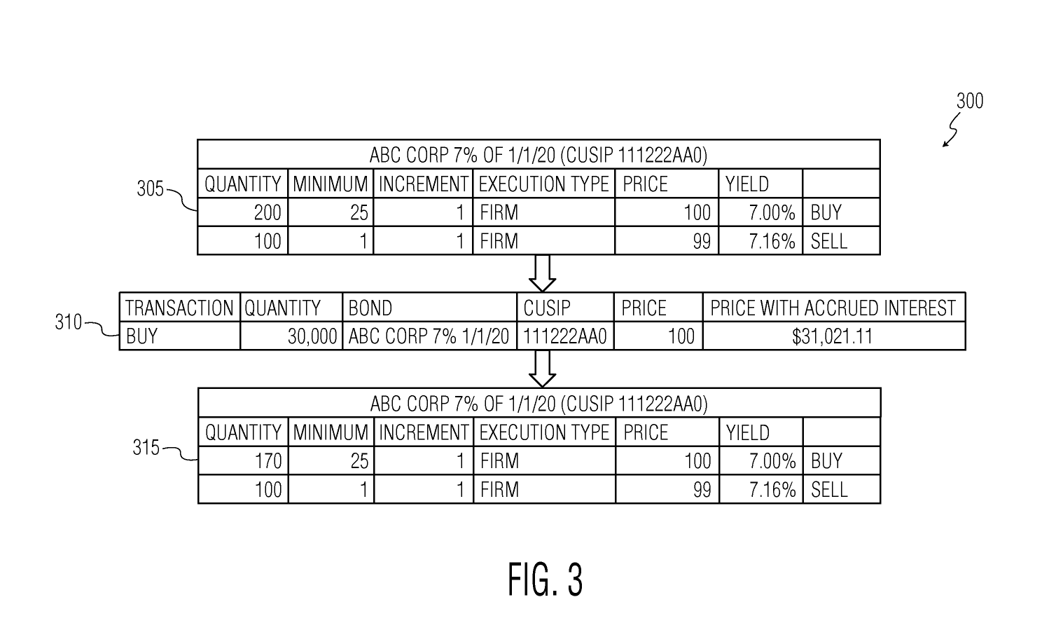

FIG. 3 illustrates the order flow 300 from a Retail Client Order to Retail ATS prior to the information being sent to the ATS Interface 135. Retail brokerage firms such as E*Trade and Merrill Lynch utilize Retail ATSs (BondDesk, BondPoint, TMC) to provide bond market access to their clients. A Retail ATS's Best Bid/Best Offer Market for ABC 7% s of 1/1/20 would be displayed electronically 305 on a brokerage firm's website to retail customers. The displayed information for a Retail ATS's Best Bid/Best Offer Market display typically includes Quantity, Minimum, Increment, Execution Type, Price, Yield, and a Buy/Sell Indicator. Quantity indicates the number of bonds that are available for trades. Minimum indicates the minimum number of bonds that may be traded. Increment indicates the unit above the minimum that a larger than minimum trade must be increased by. Execution Type indicates how the sale will be transacted (Firm, which means available for immediate execution, or Subject, which means the party that posted the order needs to be contacted for approval before trading). Price is the offered price. Yield is the return calculated from the Price. The retail customer may be restricted by the brokerage firm from attempting a midmarket execution through displaying an order on the ATS's Limit Order Book for ABC 7% s; instead, the customer may only be allowed to transact at the displayed price. Bonds typically trade in $1,000 pieces, so that a $10,000 face value piece would be referred to as “ten bonds.” By manipulating the website, the retail customer would generate an order 310. In this example, the customer entered an order to buy, 30 bonds of ABC Corp 7% 1/1/20 at a price of 100, which means 1.000 times 30 times the $1000 face value per bond, or $30,000.00. The actual price for this purchase would probably be somewhat higher, as accrued interest (if any) and commissions would be added. If the above order passed compliance review at the customer's brokerage firm, the order would be electronically transmitted to the Retail ATS and automatically executed, as the Execution Type was “Firm” (“Subject” would indicate the seller would not allow automatic executions). The Retail ATS's Best Bid/Best Offer Market for ABC 7% s of 1/1/20 315 would then be updated to indicate the sale of the 30 bonds. The following market would now be displayed on the retail brokerage websites utilizing the Retail ATS, unless the seller chose to automatically maintain the offering of 200.

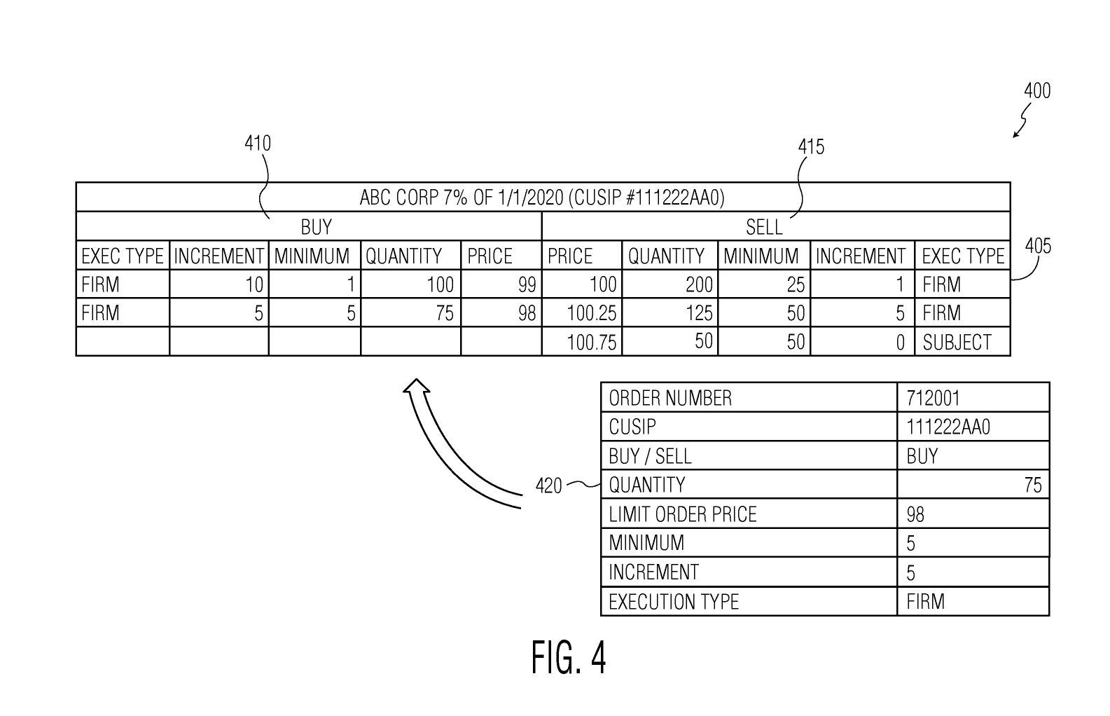

FIG. 4 illustrates the order flow 400 from limit orders display for retail ATS “liquidity provider” broker/dealer workstation prior to the information being sent to the ATS Interface 135. An ATS “liquidity provider” broker/dealer is a firm that acts as a market maker, buying and selling bonds for its own account. In FIG. 4, the Retail ATSs 110 have enabled certain Financial Industry Regulatory Authority registered (“FINRA-registered”) broker/dealers to be market makers (“Liquidity Providers”) on their ATSs. Traders at Liquidity Providers would see the full Limit Order Book 405 on their workstations. The Limited Order Book 405 includes a “Buy” section 410 and a “Sell” section 415. Traders at Liquidity Providers would be able to enter orders 420 onto the ATS through order ticket functionality. Unlike for Retail Customers, these orders could be at any chosen price, although the ATS may require orders to be near the last trade price (possibly using FINRA TRACE data).

FIG. 5 illustrates the order flow 500 from Retail ATS Limit Order Book and Institutional ATS Limit Order Book where the displays are combined and cross-channel trading is enabled by the ATS Interface 135 within Combined ATS System 100. The ATS Interface 135 displays the full Limit Order Books 505 by security for the Retail ATS and Institutional ATS. The full Limit Order Book includes a “Buy” section 510 and a “Sell” section 515. The ATS Interface also enables “Cross-Channel Trading” for “Qualifying Trades” when and if execution details match. For example, if the order 520 was generated by a Retail Liquidity Provider (FIG. 1, 115) it would be executed at 99.5, which would be the Best Offer, against the offering from the Institutional Channel. Conversely, if an Institution had 100 bonds it wanted to sell at 99, this order would be executed at 99 against the Best Bid from the Retail ATS, as the Institutional AT's Best Bid was for a minimum of 500.

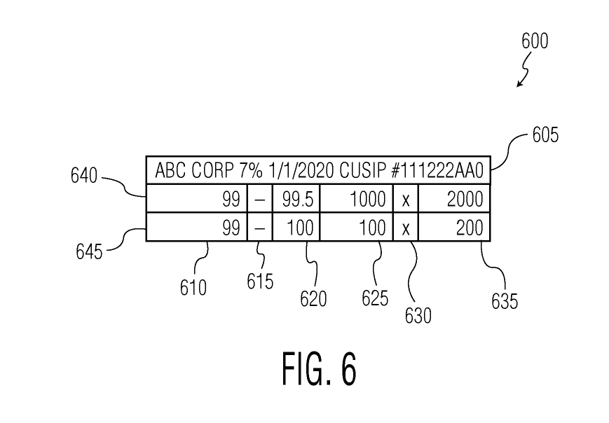

FIG. 6 illustrates a Two Track Quote 600 where information is displayed for dissemination to retail and Institutional channels within Combined ATS 100. Currently, Institutional Dealers display markets on the Bloomberg Message System (“MSG”) to their institutional clients showing their bid, offer, and the quantity (“size”) that each works for. This information is presented on a single-dealer basis, and the Best Bid and Best Offer information is not assembled from the various dealers' bids and offers. End users of the Retail ATSs see the Best Bid, Best Offer and Size that the Liquidity Providers and other users of the system provide. The “Two Track Quote” 600 would allow electronic trading and information systems, such as Bloomberg, to disseminate simultaneously the Retail and Institutional (for the Institutional Dealer or Dealers on the Institutional ATS) Best Bid and Best Offer, thereby allowing cross-channel trading through more comprehensive market knowledge for a specific bond 605.

The first column 610 of Two Track Quote 605 represents the Best Bid, with the Best Bid from the Institutional ATS (row 640) above the Best Bid from the Retail ATS (row 645). The second column 615 of Two Track Quote 605 has a “dash” which is commonly said as “to”, and represents the gap between bid and offer price. The third column 620 of Two Track Quote 605 represents the Best Offer, with the Best Offer from the Institutional ATS (row 640) above the best Offer from the Retail ATS (row 645). The fourth column 625 of Two Track Quote 605 represents the quantity in thousands that the best bid works for, or “size” of the Best Bid, with the Institutional ATS bid size shown above the Retail ATS's bid size. The fifth column 630 of Two Track Quote 605 has a “x” letter, which is commonly said as “by”. The sixth column 635 of Two Track Quote 605 represents the offer size, with the offer size for the Institutional ATS shown above the offer size for the Retail ATS. In totality, the market display in 640 would be said “ninety nine to a half, a million by two million”, and the market display in 645 “ninety nine to par, one hundred by two hundred”. The prices and trade quantities would be updated automatically as the Best Bid and Best Offer changed on both the Institutional and Retail tracks. In “Two Track Quote” 605, the first row 640 indicates the information for Institutional channels and the second row 645 indicates the information for Retail channels.

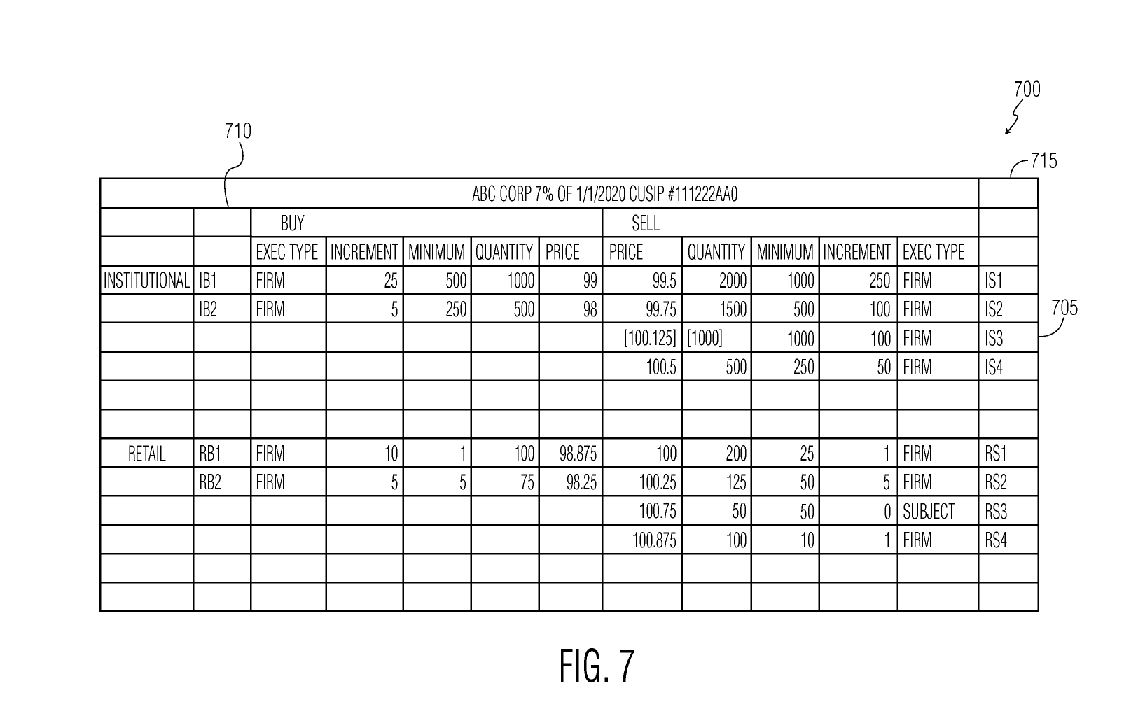

FIG. 7 illustrates the Internal Limit Order Book 700 for a “dark” order where the functionality is only available on the Institutional ATS within Combined ATS 100. As Institutional Customers such as mutual funds and hedge funds are continually executing much larger trades than retail investors, they seek to keep their trades as confidential as possible. In the equity markets, “Dark Pools” exist in parallel to the exchanges. Exchanges display live prices. Dark Pools don't display prices, but allow Institutions to post bids or offers that are only actionable by other Institutions looking to execute in the other directions (for example, sell orders are only seen by buyers). Allowing Dark Order functionality on the Institutional ATS would add order flow, and increase the viability of the Institutional ATS. A Dark Order (sell 1,000,000 ABC Corp 7% s of 2020 at 100.125) is shown on the internal Limit Order Book 705 for the ATS Interface 135, and indicated by brackets. As this order is Dark, it would not be displayed on either the “Two Track Quotation”, the Institutional ATS's Limit Order Book, or the Limit Order Book of the Institutional/Retail Interface. Institutional anonymity is ensured through the use of non-identifying designations for the institutional and retail participants as shown in columns 710 and 715. IB1 is Institutional Buyer 1, RS1 is Retail Seller 1, etc.

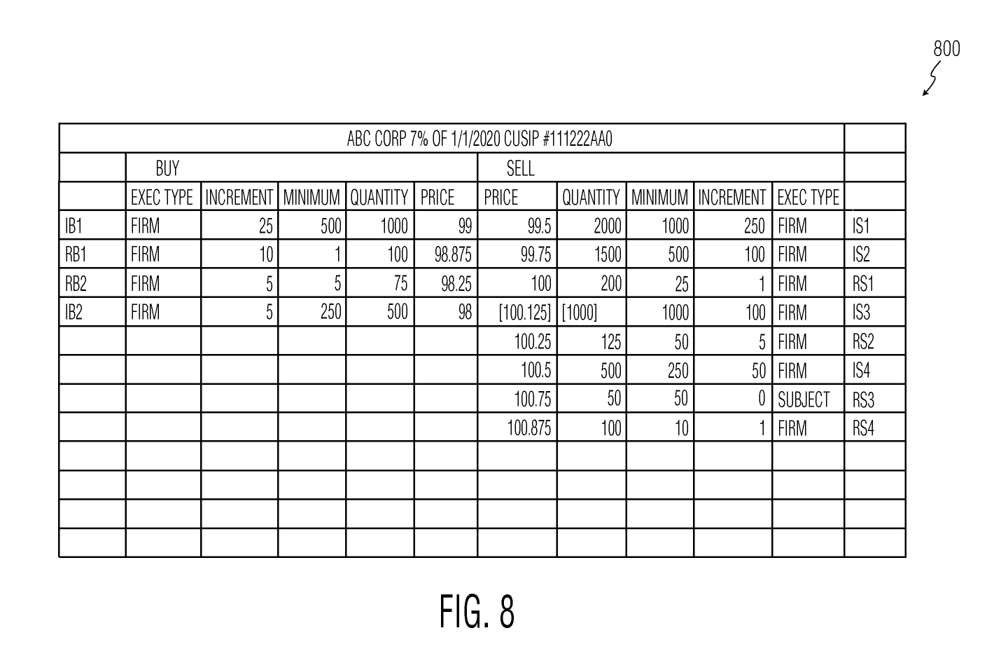

FIG. 8 illustrates an internal limit order book 800 for ATS Interface 135 within the Combined ATS 100. IB1 is Institutional Buyer 1, RS3 is Retail Seller 3, etc. The ATS Interface 135 enhances corporate bond trading by combining the order streams of Retail ATS or ATSs and Institutional ATS or ATSs. The ATS Interface Processor puts orders for a given security in price priority order, (for example) which is the logic behind a Limit Order Book. The ATS Interface Processor creates value by applying the specific trade protocols and Pre-Coded Customer Preferences to maximize transactions. The Processor constructs a Combined Limit Order Book 800 from the Limit Order Books of the Institutional ATS or ATSs and Retail ATS or ATSs. Although the orders in 800 are the same as in 700 in FIG. 7, they have been prioritized by price, representing visually the price priority logic which will be applied in transaction evaluation.

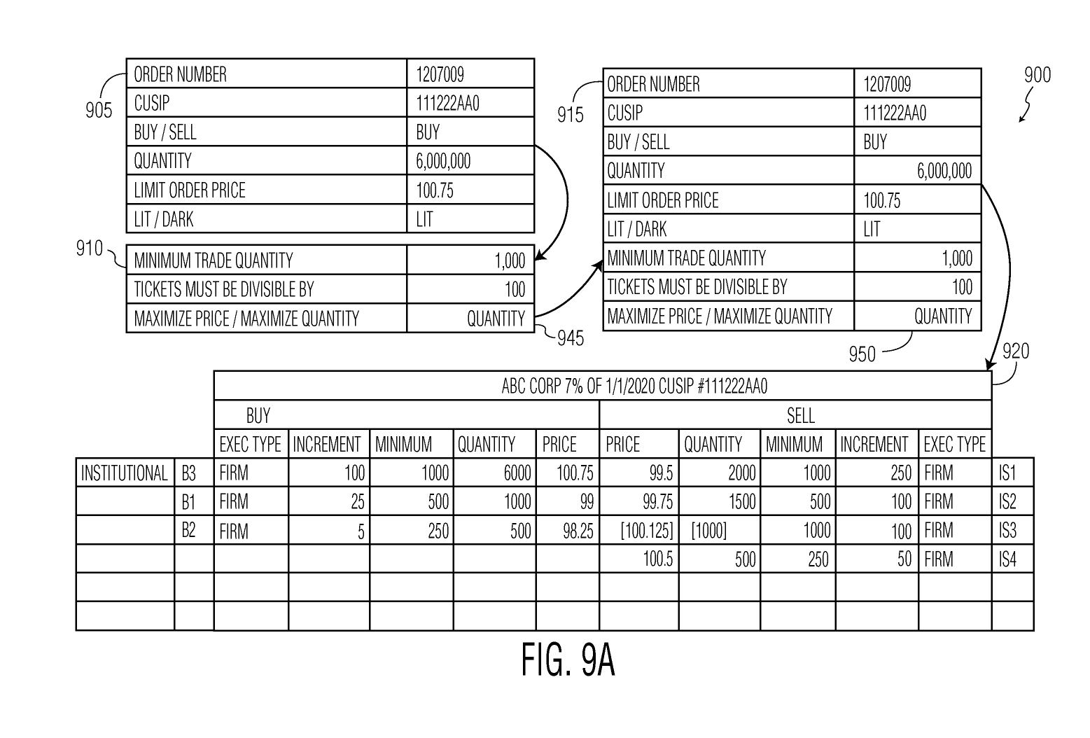

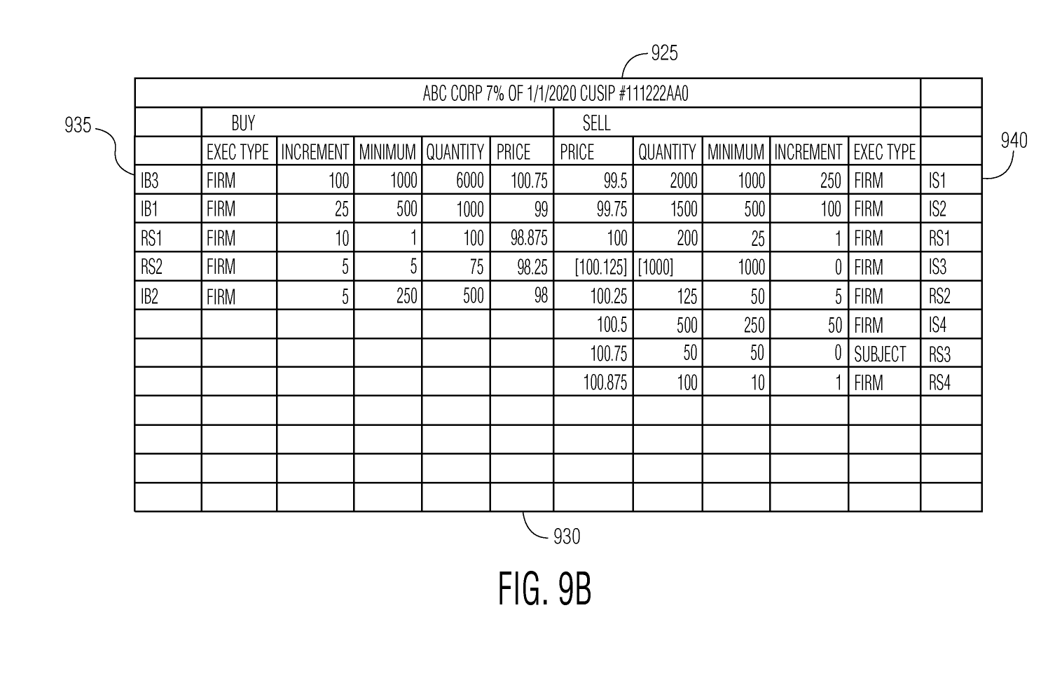

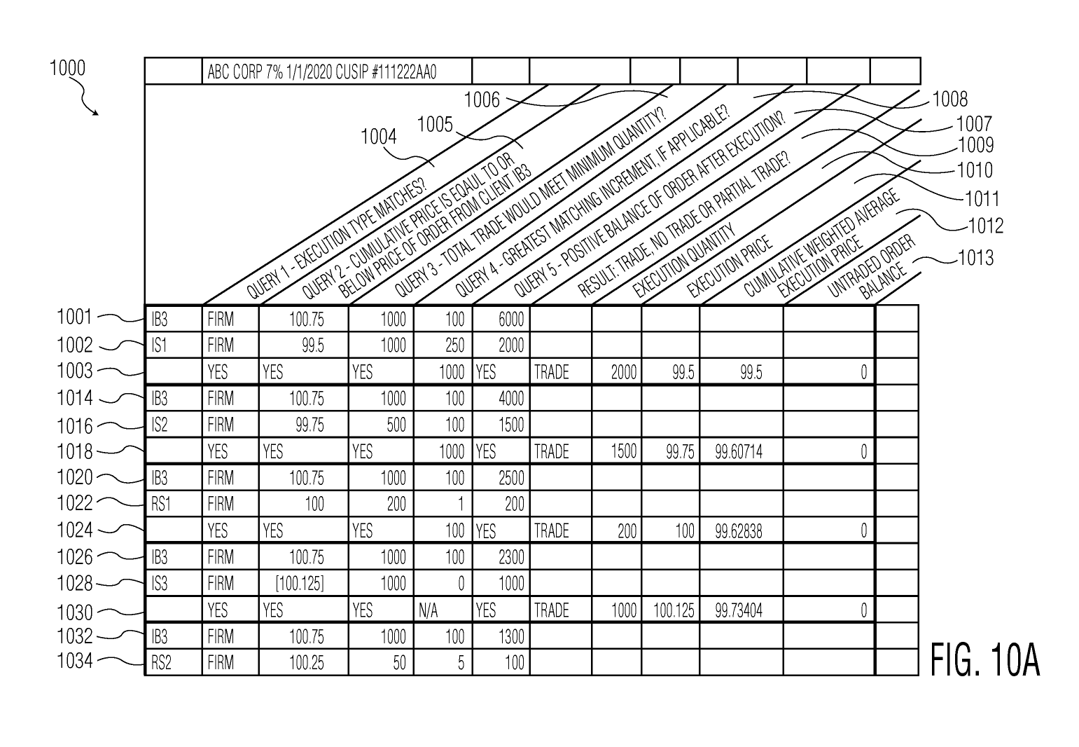

FIGS. 9A-B illustrate order flow of how the ATS Interface 135 directs trading within and between Retail and Institutional ATSs within Combined ATS 100. The Order Ticket 905 (#1207009) was transmitted by Institutional Client A to the Institutional ATS Processor in XML format. Institutional Client A's pre-coded trade preferences 910 were added to Order Ticket #1207009 by the Institutional ATS's processor to form Transaction Order Ticket #1207009 915. Transaction Order Ticket #1207009 915 was added by the processor to the Limit Order Book 920 for CUSIP #111222AAO. The Institutional ATS's Limit Order Book is shown 920. The processor automatically transmits its updated Limit Order Book 920 for CUSIP #111222AAO to the ATS Interface Processor. The ATS Interface Processor updates its Combined Limit Order Book 925 (FIG. 9B) with the orders transmitted by the Institutional ATS. The orders from each enabled ATS are commingled and ranked in price priority order 930. Upon completing the price priority ranking of the orders, the ATS Interface Processor subtracts the price of the Best Bid (100.75) 935 from the Best Offer (99.5) 940. As the sum is negative, the Buy Order from buyer IB3 is Marketable and the ATS Interface Processor launches its Trade Execution module 1000 (FIG. 10).

As shown in FIG. 10, the Trade Execution Module 1000 automatically evaluates each Offer Order in price priority order (for this example). One of ordinary skill in the art would understand that other priorities may be used and are within the scope of the invention. Initially, the Trade Execution Module 1000 will evaluate IB3's buy order with IS1's offer to sell. The first row 1001 of Trade Execution Module 1000 contains the information pertaining to IB3's buy order, namely the execution type (Firm), the price IB3 is willing to pay (100.75), the minimum quantity (1000), the increment (100), and the number of bonds IB3 is attempting to purchase (6000). The second row 1002 of Trade Execution Module 1000 contains the information pertaining to IS1's offer to sell, namely the execution type (Firm), the price IS1 is willing to sell at (99.5), the minimum quantity (1000), the increment (250), and the number of bonds IS1 has to sell (2000). The third row 1003 of Trade Execution Module 1000 contains the relevant information to each of the Queries 1-5. Query 1 1004 asks if the Exec Type Matches? The execution type for both is “Firm”, so this does match and that information (“Yes”) is recorded in the second block of row 1003. Query 2 1005 asks if the Price is equal to or below Order from Client IB3? In this case IB3 is willing to buy at 100.75 and IS1 is willing to sell at 99.5, so the answer again is “Yes” which is recorded in the third block of row 1003. Query 3 1006 is if it Meets Minimum Quantity? Each of the minimum quantities in this case is 1000, so the response is “Yes” which is recorded in the fourth block of row 1003. Query 5 1007 asks if there is a Positive Balance of Order After Execution? Since IB3 desires to purchase 6000 bonds and IS1 has 2000 bonds to sell, the balance after the proposed transaction between IB3 and IS1 is “4000”, and a “YES” is recorded in the sixth block of row 1003. Query 4 1008 asks for the greatest matching increment (if applicable). Since IB3 had an increment of 100 and IS1 had an increment of 250, the greatest matching increment is 1000, which is recorded in block 5 of row 1003. The processor adds increments as determined by Query 4 1008 until the quantity of Offer Order IS1 has been reduced to zero or no longer has an increment acceptable under the terms of Buy Order IB3 or Sell Order IS1. As illustrated by FIG. 10, this process is iterated until IB3 has purchased all of the desired bonds, or until there are no additional bonds available for IB3 to purchase at mutually agreeable terms. As Offer Order IS1 has affirmative responses to Queries 1, 2, 3 and 5, and has an Increment which allows for more bonds to be traded above the Minimum, the Trade Execution Module 1000 calculates the maximum tradable quantity and marks “TRADE” in block 7 of row 1003 in the column labeled “Result: Trade, No Trade, or Partial Trade” 1009 and Reserved. Also recorded in row 1003 are the Execution Quantity 1010 (2000), the Execution Price 1011 (99.5), the Cumulative Weighted Average Execution Price 1012 (99.5) and the Untraded Order Balance 1013 (0).

The Trade Execution Module 1000 then proceeds to evaluate Offer Order IS2. Bid Order IB3's Balance has been reduced (to 4000 addition shares) by the prior trade with IS1. During this evaluation, the Trade Execution Module 1000 will evaluate any remaining portion of IB3's buy order with IS2's offer to sell. The next row 1014 of Trade Execution Module 1000 contains the information pertaining to any remaining portion of IB3's buy order, namely the execution type (Firm), the price IB3 is willing to pay (100.75), the minimum quantity (1000), the increment (100), and the number of remaining bonds IB3 is attempting to purchase (4000). The next row 1016 of Trade Execution Module 1000 contains the information pertaining to IS2's offer to sell, namely the execution type (Firm), the price IS2 is willing to sell at (99.75), the minimum quantity (500), the increment (100), and the number of bonds IS2 had to sell (1500). The next row 1018 of Trade Execution Module 1000 contains the relevant information to each of the Queries 1-5. Query 1 1004 asks if the Exec Type Matches? The execution type for both is “Firm”, so this does match and that information (“Yes”) is recorded in the second block of row 1018. Query 2 1005 asks if the Price is equal to or below Order from Client IB3? In this case IB3 is willing to buy at 100.75 and IS2 is willing to sell at 99.75, so the answer again is “Yes” which is recorded in the third block of row 1018. Query 3 1006 is if it Meets Minimum Quantity? The Minimum Quantity for IB3 is 1000 and the Minimum Quantity for IS2 is 500, so the response is “Yes” which is recorded in the fourth block of row 1018. Query 5 1007 asks if there is a Positive Balance of Order After Execution? Since IB3 desires to purchase 4000 additional bonds and IS2 has 1500 bonds to sell, the balance after the proposed transaction between IB3 and IS2 is “2500”, and a “YES” is recorded in the sixth block of row 960. Query 4 1008 asks for the greatest matching increment (if applicable). Since IB3 had an increment of 100 and IS2 had an increment of 100, the greatest matching increment is 1000, which is recorded in block 5 of row 1018. The processor adds increments as determined by Query 4 1008 until the quantity of Offer Order IS2 has been reduced to zero or no longer has an increment acceptable under the terms of Buy Order IB3 or Sell Order IS2. As Offer Order IS2 has affirmative responses to Queries 1, 2, 3 and 5, and has an Increment which allows for more bonds to be traded above the Minimum, the Trade Execution Module 1000 calculates the maximum tradable quantity and marks “TRADE” in block 7 of row 1018 in the column labeled “Result: Trade, No Trade, or Partial Trade” 1009 and Reserved. Also recorded in row 1018 are the Execution Quantity 1010 (1500), the Execution Price 1011 (99.75), the Cumulative Weighted Average Execution Price 1012 (99.60714) and the Untraded Order Balance 1013 (0).

As illustrated by FIG. 10, this process is iterated until IB3 has purchased all of the desired bonds, or until there are no additional bonds available for IB3 to purchase at mutually agreeable terms.

The Trade Execution Module 1000 then proceeds to evaluate Offer Order from RS1. Bid Order IB3's Balance has been reduced (to 2500 addition shares) by the prior trades with IS1 and IS2. During this evaluation, the Trade Execution Module 1000 will evaluate any remaining portion of IB3's buy order with RS1's offer to sell. The next row 1020 of Trade Execution Module 1000 contains the information pertaining to any remaining portion of IB3's buy order, namely the execution type (Firm), the price IB3 is willing to pay (100.75), the minimum quantity (1000), the increment (100), and the number of remaining bonds IB3 is attempting to purchase (2500). The next row 1022 of Trade Execution Module 1000 contains the information pertaining to RS1's offer to sell, namely the execution type (Firm), the price RS1 is willing to sell at (100), the minimum quantity (200), the increment (1), and the number of bonds RS1 has to sell (200). The next row 1024 of Trade Execution Module 1000 contains the relevant information to each of the Queries 1-5. Query 1 1004 asks if the Exec Type Matches? The execution type for both is “Firm”, so this does match and that information (“Yes”) is recorded in the second block of row 1024. Query 2 1005 asks if the Price is equal to or below Order from Client IB3? In this case IB3 is willing to buy at 100.75 and RS1 is willing to sell at 100, so the answer again is “Yes” which is recorded in the third block of row 1024. Query 3 1006 is if it Meets Minimum Quantity? The Minimum Quantity for IB3 is 1000 and the Minimum Quantity for RS1 is 200, so the response is “Yes” which is recorded in the fourth block of row 1024. Query 5 1007 asks if there is a positive Balance of Order After Execution? Since IB3 desires to purchase 2500 additional bonds and RS 1 has 200 bonds to sell, the balance after the proposed transaction between IB3 and RS1 is “2300”, and a “YES” is recorded in the sixth block of row 1024. Query 4 1008 asks for the greatest matching increment (if applicable). Since IB3 had an increment of 100 and RS1 has an increment of 1, the greatest matching increment is 100, which is recorded in block 5 of row 1024. The processor adds increments as determined by Query 4 1008 until the quantity of Offer Order RS1 has been reduced to zero or no longer has an increment acceptable under the terms of Buy Order IB3 or Sell Order RS1. As Offer Order RS1 has affirmative responses to Queries 1, 2, 3 and 5, and has an Increment which allows for more bonds to be traded above the Minimum, the Trade Execution Module 1000 calculates the maximum tradable quantity and marks “TRADE” in block 7 of row 1024 in the column labeled “Result: Trade, No Trade, or Partial Trade” 1009 and Reserved. Also recorded in row 1024 are the Execution Quantity 1010 (200), the Execution Price 1011 (100), the Cumulative Weighted Average Execution Price 1012 (99.62838) and the Untraded Order Balance 1013 (0).

The Trade Execution Module 1000 then proceeds to evaluate Offer Order from IS3. IS3 is a “Dark Order” as indicated by the brackets, and has not been displayed in either the Two Track Quote (FIG. 6) or Institutional Dealer's ATS's Limit Order Book (220). Bid Order IB3's Balance has been reduced (to 2300 addition shares) by the prior trades with IS1, IS2 and RS1. During this evaluation, the Trade Execution Module 1000 will evaluate any remaining portion of IB3's buy order with IS3's offer to sell. The next row 1026 of Trade Execution Module 1000 contains the information pertaining to any remaining portion of IB3's buy order, namely the execution type (Firm), the price IB3 is willing to pay (100.75), the minimum quantity (1000), the increment (100), and the number of remaining bonds IB3 is attempting to purchase (2300). The next row 1028 of Trade Execution Module 1000 contains the information pertaining to IS3's offer to sell, namely the execution type (Firm), the price IS3 is willing to sell at (100.125), the minimum quantity (1000), the increment (0), and the number of bonds IS3 has to sell (1000). The next row 1030 of Trade Execution Module 1000 contains the relevant information to each of the Queries 1-5. Query 1 1004 asks if the Exec Type Matches? The execution type for both is “Firm”, so this does match and that information (“Yes”) is recorded in the second block of row 1030. Query 2 1005 asks if the Price is equal to or below Order from Client IB3? In this case IB3 is willing to buy at 100.75 and IS3 is willing to sell at 100.125, so the answer again is “Yes” which is recorded in the third block of row 1030. Query 3 1006 is if it Meets Minimum Quantity? The Minimum Quantity for IB3 is 1000 and the Minimum Quantity for IS3 is 1000, so the response is “Yes” which is recorded in the fourth block of row 1030. Query 5 1007 asks if there is a positive Balance of Order After Execution? Since IB3 desires to purchase 2300 additional bonds and IS3 has 1000 bonds to sell, the balance after the proposed transaction between IB3 and IS3 is “1300”, and a “YES” is recorded in the sixth block of row 1024. Query 4 1008 asks for the greatest matching increment (if applicable). Since IB3 had an increment of 100 and IS3 has an increment of 0, the greatest matching increment is N/A, which is recorded in block 5 of row 1030. The processor adds increments as determined by Query 4 1008 until the quantity of Offer Order IS3 has been reduced to zero or no longer has an increment acceptable under the terms of Buy Order IB3 or Sell Order IS3. As Offer Order IS3 has affirmative responses to Queries 1, 2, 3 and 5, and has an Increment which allows for more bonds to be traded above the Minimum, the Trade Execution Module 1000 calculates the maximum tradable quantity and marks “TRADE” in block 7 of row 1030 in the column labeled “Result: Trade, No Trade, or Partial Trade” 1009 and Reserved. Also recorded in row 1030 are the Execution Quantity 1010 (1000), the Execution Price 1011 (100.125), the Cumulative Weighted Average Execution Price 1012 (99.73404) and the Untraded Order Balance 1013 (0).

The Trade Execution Module 1000 then proceeds to evaluate Offer Order from RS2. Bid Order IB3's Balance has been reduced (to 1300 addition shares) by the prior trades with IS1, IS2, RS1 and IS3. During this evaluation, the Trade Execution Module 1000 will evaluate any remaining portion of IB3's buy order with RS2's offer to sell. The next row 1032 of Trade Execution Module 1000 contains the information pertaining to any remaining portion of IB3's buy order, namely the execution type (Firm), the price IB3 is willing to pay (100.75), the minimum quantity (1000), the increment (100), and the number of remaining bonds IB3 is attempting to purchase (1300). The next row 1034 of Trade Execution Module 1000 contains the information pertaining to RS2's offer to sell, namely the execution type (Firm), the price RS2 is willing to sell at (100.25), the minimum quantity (50), the increment (5), and the number of bonds RS2 has to sell (100). However, as RS2 is a retail order, which allows for Minimums and Increments smaller than the Institutional ATS's (Minimum is 500), only 100 of the bonds can be traded. A partial trade of 100 bonds is possible; 100 bonds are marked “Partial” and Reserved. The 25 bonds which were not traded remain as an unfilled Offer Order under the same RS2 Offer Order. The next row 1036 of Trade Execution Module 1000 contains the relevant information to each of the Queries 1-5. Query 1 1004 asks if the Exec Type Matches? The execution type for both is “Firm”, so this does match and that information (“Yes”) is recorded in the second block of row 1036. Query 2 1005 asks if the Price is equal to or below Order from Client IB3? In this case IB3 is willing to buy at 100.75 and RS2 is willing to sell at 100.25, so the answer again is “Yes” which is recorded in the third block of row 1036. Query 3 1006 is if it Meets Minimum Quantity? The Minimum Quantity for IB3 is 1000 and the Minimum Quantity for RS2 is 50, so the response is “Yes” which is recorded in the fourth block of row 1036. Query 5 1007 asks if there will be a positive Balance of Order After Execution? Since IB3 desires to purchase 1300 additional bonds and RS2 has 100 bonds to sell, the balance after the proposed transaction between IB3 and RS2 is “1200”, and a “YES” is recorded in the sixth block of row 1036. Query 4 1008 asks for the greatest matching increment (if applicable). Since IB3 had an increment of 100 and RS2 has an increment of 5, the greatest matching increment is 50, which is recorded in block 5 of row 1036. The processor adds increments as determined by Query 4 1008 until the quantity of Offer Order RS2 has been reduced to zero or no longer has an increment acceptable under the terms of Buy Order IB3 or Sell Order RS2. As Offer Order RS2 has affirmative responses to Queries 1, 2, 3 and 5, and has an Increment which allows for more bonds to be traded above the Minimum, the Trade Execution Module 1000 calculates the maximum tradable quantity and marks “PARTIAL” in block 7 of row 1036 in the column labeled “Result: Trade, No Trade, or Partial Trade” 1009 and Reserved. Also recorded in row 1036 are the Execution Quantity 1010 (100), the Execution Price 1011 (100.25), the Cumulative Weighted Average Execution Price 1012 (99.74479) and the Untraded Order Balance 1013 (25).

The Trade Execution Module 1000 then proceeds to evaluate Offer Order from IS4. Bid Order IB3′ s Balance has been reduced (to 1200 addition shares) by the prior trades with IS1, IS2, RS1, IS3, and RS2. During this evaluation, the Trade Execution Module 1000 will evaluate any remaining portion of IB3's buy order with IS4's offer to sell. The next row 1038 of Trade Execution Module 1000 contains the information pertaining to any remaining portion of IB3's buy order, namely the execution type (Firm), the price IB3 is willing to pay (100.75), the minimum quantity (1000), the increment (100), and the number of remaining bonds IB3 is attempting to purchase (1200). The next row 1040 of Trade Execution Module 1000 contains the information pertaining to IS4's offer to sell, namely the execution type (Firm), the price IS4 is willing to sell at (100.5), the minimum quantity (250), the increment (50), and the number of bonds IS4 has to sell (500). The next row 1042 of Trade Execution Module 1000 contains the relevant information to each of the Queries 1-5. Query 1 1004 asks if the Exec Type Matches? The execution type for both is “Firm”, so this does match and that information (“Yes”) is recorded in the second block of row 1036. Query 2 1005 asks if the Price is equal to or below Order from Client IB3? In this case IB3 is willing to buy at 100.75 and IS4 is willing to sell at 100.5, so the answer again is “Yes” which is recorded in the third block of row 1042. Query 3 1006 is if it Meets Minimum Quantity? The Minimum Quantity for IB3 is 1000 and the Minimum Quantity for IS4 is 500, so the response is “Yes” which is recorded in the fourth block of row 1042. Query 5 1007 asks Balance of Order After Execution? Since IB3 desires to purchase 1200 additional bonds and IS4 has 500 bonds to sell, the balance after the proposed transaction between IB3 and IS2 is “700”, and a “YES” is recorded in the sixth block of row 1042. Query 4 1008 asks for the greatest matching increment (if applicable). Since IB3 had an increment of 100 and IS4 has an increment of 50, the greatest matching increment is 250, which is recorded in block 5 of row 1042. The processor adds increments as determined by Query 4 1008 until the quantity of Offer Order IS4 has been reduced to zero or no longer has an increment acceptable under the terms of Buy Order IB3 or Sell Order IS4. As Offer Order IS4 has affirmative responses to Queries 1, 2, 3 and 5, and has an Increment which allows for more bonds to be traded above the Minimum, the Trade Execution Module 1000 calculates the maximum tradable quantity and marks “TRADE” in block 7 of row 1042 in the column labeled “Result: Trade, No Trade, or Partial Trade” 1009 and Reserved. Also recorded in row 1042 are the Execution Quantity 1010 (500), the Execution Price 1011 (100.5), the Cumulative Weighted Average Execution Price 1012 (99.81604) and the Untraded Order Balance 1013 (0).

The Trade Execution Module 1000 then proceeds to evaluate Offer Order from RS2 at its new quantity of 25. Bid Order IB3's Balance has been reduced (to 700 addition shares) by the prior trades with IS1, IS2, RS1, IS3, RS2, and IS4. During this evaluation, the Trade Execution Module 1000 will evaluate any remaining portion of IB3's buy order with RS2's offer to sell its remaining 25 bonds. The next row 1044 of Trade Execution Module 1000 contains the information pertaining to any remaining portion of IB3's buy order, namely the execution type (Firm), the price IB3 is willing to pay (100.75), the minimum quantity (1000), the increment (100), and the number of remaining bonds IB3 is attempting to purchase (700). The next row 1046 of Trade Execution Module 1000 contains the information pertaining to RS2's offer to sell its remaining 25 bonds, namely the execution type (Firm), the price RS2 is willing to sell at (100.25), the minimum quantity (25), the increment (5), and the number of bonds RS2 has left to sell (25). In this case the minimum quantity of 25 is acceptable because the ATS Interface 135 is calculating the best trade, and the sell orders which qualify are being reserved for later execution upon conclusion of the trade evaluation process. The next row 1048 of Trade Execution Module 1000 contains the relevant information to each of the Queries 1-5. Query 1 1004 asks if the Exec Type Matches? The execution type for both is “Firm”, so this does match and that information (“Yes”) is recorded in the second block of row 1048. Query 2 1005 asks if the Price is equal to or below Order from Client IB3? In this case IB3 is willing to buy at 100.75 and RS2 is willing to sell at 100.25, so the answer again is “Yes” which is recorded in the third block of row 1048. Query 3 1006 is if it Meets Minimum Quantity? The Minimum Quantity for IB3 is 1000 and the Minimum Quantity for RS2 is 25, so the response is “Yes” which is recorded in the fourth block of row 1048. Query 5 1007 asks if there is a positive Balance of Order After Execution? Since IB3 desires to purchase 700 additional bonds and RS2 has 25 additional bonds to sell, the balance after the proposed transaction between IB3 and IS2 is “675”, if that transaction was allowed and a “YES” is entered into the sixth block of row 1048. Query 4 1008 asks for the greatest matching increment (if applicable). Since IB3 had an increment of 100 and RS2 has an increment of (5), the greatest matching increment is 0, which is recorded in block 5 of row 1048. Although the answers to Queries 1, 2, 3 and 5 are positive, the maximum executable quantity fails to exceed the prior quantity by Bid Order's Increment and this potential transaction is marked “NO TRADE”. Here, the Trade Execution Module 1000 marks “NO TRADE” in block 7 of row 1048 in the column labeled “Result: Trade, No Trade, or Partial Trade” 1009. Also recorded in row 1048 are the Execution Quantity 1010 (0), the Execution Price 1011 (0), the Cumulative Weighted Average Execution Price 1012 (0) and the Untraded Order Balance 1013 (25).

The Trade Execution Module 1000 then proceeds to evaluate Offer Order from RS3. Bid Order IB3's Balance has been reduced (to 700 addition shares) by the prior trades with IS1, IS2, RS1, IS3, RS2, and IS4. During this evaluation, the Trade Execution Module 1000 will evaluate any remaining portion of IB3's buy order with RS3's offer to sell. The next row 1050 of Trade Execution Module 1000 contains the information pertaining to any remaining portion of IB3's buy order, namely the execution type (Firm), the price IB3 is willing to pay (100.75), the minimum quantity (1000), the increment (100), and the number of remaining bonds IB3 is attempting to purchase (700). The next row 1052 of Trade Execution Module 1000 contains the information pertaining to RS3's offer to sell, namely the execution type (Subject), the price RS3 is willing to sell at (100.75), the minimum quantity (50), the increment (0), and the number of bonds RS3 has to sell (50). The next row 1054 of Trade Execution Module 1000 contains the relevant information to each of the Queries 1-5. Query 1 1004 asks if the Exec Type Matches? The execution type for IB3 is Firm and the execution type for RS3 is Subject. Since these don't match, that information (“No”) is recorded in the second block of row 1054. No additional analysis is required between IB3 and RS3 so, in one embodiment, the analysis for this potential transaction ends at that point. In other embodiments, Query 2 1005 asks if the Price is equal to or below Order from Client IB3? In this case IB3 is willing to buy at 100.75 and RS3 is willing to sell at 100.75, so the answer again is “Yes” which is recorded in the third block of row 1054. Query 3 1006 is if it Meets Minimum Quantity? The Minimum Quantity for IB3 is 1000 and the Minimum Quantity for RS3 is 50, so the response is “Yes” which is recorded in the fourth block of row 1054. Query 5 1007 asks there is a positive Balance of Order After Execution? Since IB3 desires to purchase 700 additional bonds and RS3 has 50 bonds to sell, the balance after the proposed transaction between IB3 and IS2 is “650”, if that transaction was allowed and a “YES” is included in the sixth block of row 1048. Query 4 1008 asks for the greatest matching increment (if applicable). Since IB3 had an increment of 100 and RS3 has an increment of 0, the greatest matching increment is “N/A” or not applicable, so “N/A” is recorded in block 5 of row 1054. Since the answer to Query 1 is negative, this potential transaction is marked “NO TRADE”. Here, the Trade Execution Module 1000 marks “NO TRADE” in block 7 of row 1054 in the column labeled “Result: Trade, No Trade, or Partial Trade” 1009. Also recorded in row 1054 are the Execution Quantity 1010 (0), the Execution Price 1011 (0), the Cumulative Weighted Average Execution Price 1012 (0) and the Untraded Order Balance 1013 (50).

Since this example is price sensitive, one of ordinary skill in the art would appreciate that the Trade Execution Module 1000 will now evaluate any remaining portion of IB3's buy with RS2's offer to sell its remaining 25 bonds. Rows 1044-1048 would be repeated, and the Trade Execution Module 1000 would again decide “No Trade” at this point. For brevity, the duplication of rows 1044-1048 have not been included in FIG. 10B.

The Trade Execution Module 1000 then proceeds to evaluate Offer Order from RS4. Bid Order IB3's Balance has been reduced (to 700 addition shares) by the prior trades with IS1, IS2, RS1, IS3, RS2, and IS4. During this evaluation, the Trade Execution Module 1000 will evaluate any remaining portion of IB3's buy order with RS4's offer to sell. The next row 1056 of Trade Execution Module 1000 contains the information pertaining to any remaining portion of IB3's buy order, namely the execution type (Firm), the price IB3 is willing to pay (100.75), the minimum quantity (1000), the increment (100), and the number of remaining bonds IB3 is attempting to purchase (700). The next row 1058 of Trade Execution Module 1000 contains the information pertaining to RS4's offer to sell, namely the execution type (Firm), the price RS4 is willing to sell at (100.875), the minimum quantity (10), the increment (1), and the number of bonds RS4 has to sell (100). The next row 1060 of Trade Execution Module 1000 contains the relevant information to each of the Queries 1-5. Query 1 1004 asks if the Exec Type Matches? The execution type for both IB3 and RS4 is “Firm” so these match and “YES” is recorded in the second block of row 1060. Query 2 1005 asks if the Price is equal to or below Order from Client IB3? In this case IB3 is willing to buy at 100.75 and RS4 is willing to sell at 100.875, however, since the pre-coded instructions for this institutional buyer (FIG. 9A, 945) are to maximize quantity, the Transaction Order Ticket 915 was also coded to maximize quantity (FIG. 9A, 950) so the processor will continue with this trade even though the price exceeds 100.75 because the Cumulative Weighted Average Execution Price is still below 100.75. The Trade Execution Module 1000 calculates the maximum tradable quantity and marks “TRADE” in block 7 of row 1060 in the column labeled “Result: Trade, No Trade, or Partial Trade” 1009 and Reserved. Also recorded in row 1060 are the Execution Quantity 1010 (100), the Execution Price 1011 (100.875), the Cumulative Weighted Average Execution Price 1012 (99.83565) and the Untraded Order Balance 1013 (0).

The Trade Execution Module 1000 then proceeds to evaluate Offer Order from RS2 at its new quantity of 25 again because RS2 is at a lower price than RS4. Bid Order IB3's Balance has been reduced (to 600 addition shares) by the prior trades with IS1, IS2, RS1, IS3, RS2, IS4 and RS4. During this evaluation, the Trade Execution Module 1000 will evaluate any remaining portion of IB3's buy order with RS2's offer to sell its remaining 25 bonds. The next row 1062 of Trade Execution Module 1000 contains the information pertaining to any remaining portion of IB3's buy order, namely the execution type (Firm), the price IB3 is willing to pay (100.75), the minimum quantity (1000), the increment (100), and the number of remaining bonds IB3 is attempting to purchase (600). The next row 1064 of Trade Execution Module 1000 contains the information pertaining to RS2's offer to sell its remaining 25 bonds, namely the execution type (Firm), the price RS2 is willing to sell at (100.25), the minimum quantity (25), the increment (5), and the number of bonds RS2 has left to sell (25). In this case the minimum quantity of 25 is acceptable because the ATS Interface 135 is calculating the best trade, and the sell orders which qualify are being reserved for later execution upon conclusion of the trade evaluation process. The next row 1066 of Trade Execution Module 1000 contains the relevant information to each of the Queries 1-5. Query 1 1004 asks if the Exec Type Matches? The execution type for both is “Firm”, so this does match and that information (“Yes”) is recorded in the second block of row 1066. Query 2 1005 asks if the Price is equal to or below Order from Client IB3? In this case IB3 is willing to buy at 100.75 and RS2 is willing to sell at 100.25, so the answer again is “Yes” which is recorded in the third block of row 1066. Query 3 1006 is if it Meets Minimum Quantity? Query 3 is calculated to be positive only if the quantity of Offer Order RS4 is reduced to 75. Since IB3 had an increment of 100 and RS2 has an increment of (5), the greatest matching increment is 0, which is recorded in block 5 of row 1066. As this revision maintains price priority order, offer Order RS 2 is marked “TRADE” in block 7 of row 1066 in the column labeled “Result: Trade, No Trade, or Partial Trade” 1009 and Reserved. Also recorded in row 1066 are the Execution Quantity 1010 (25), the Execution Price 1011 (100.25), the Cumulative Weighted Average Execution Price 1012 (99.83756) and the Untraded Order Balance 1013 (0).

The Trade Execution Module 1000 than proceeds to revise Offer Order RS4 to 75 marked “TRADE” and Reserved and 25 bonds are recorded in the “Untraded Bonds” column. The next row 1068 of Trade Execution Module 1000 contains the information pertaining to any remaining portion of IB3's buy order, namely the execution type (Firm), the price IB3 is willing to pay (100.75), the minimum quantity (1000), and the increment (100). The next row 1070 of Trade Execution Module 1000 contains the information pertaining to RS4's offer to sell, namely the execution type (Firm), the price RS4 is willing to sell at (100.875), the change in quantity (−25), the increment (1), and the change in the number of bonds RS4 will be selling (−25). Offer Order RS4 is marked “TRADE REDUCED” in block 7 of row 1070 in the column labeled “Result: Trade, No Trade, or Partial Trade” 1009 and Reserved. Also recorded in row 1070 are the Execution Quantity 1010 (−25), the Execution Price 1011 (100.875), the Cumulative Weighted Average Execution Price 1012 (99.83275) and the Untraded Order Balance 1013 (25). The next row 1072 of Trade Execution Module 1000 contains the updated information pertaining to IB3's buy order, namely the execution type (Firm), the price IB3 is willing to pay (100.75), the minimum quantity (1000), the increment (100) and the remaining bonds IB3 is attempting to buy (600). Since RS2 was at a lower price (100.25) than RS4 (100.875) the processor adjusted its purchase decision to buy the lower priced bonds. The processor is minimizing the purchase price for the order IB3 and enforcing price priority among the orders.

The Trade Execution Module 1000 then proceeds to evaluate Offer Order from RS3 again. Bid Order IB3's Balance has been reduced (to 600 addition shares) by the prior trades with IS1, IS2, RS1, IS3, RS2, IS4, and RS4. During this evaluation, the Trade Execution Module 1000 will evaluate any remaining portion of IB3's buy order with RS3's offer to sell. The next row 1074 of Trade Execution Module 1000 contains the information pertaining to any remaining portion of IB3's buy order, namely the execution type (Firm), the price IB3 is willing to pay (100.75), the minimum quantity (1000), the increment (100), and the number of remaining bonds IB3 is attempting to purchase (600). The next row 1076 of Trade Execution Module 1000 contains the information pertaining to RS3's offer to sell, namely the execution type (Subject), the price RS3 is willing to sell at (100.75), the minimum quantity (50), the increment (0), and the number of bonds RS3 has to sell (50). The next row 1078 of Trade Execution Module 1000 contains the relevant information to each of the Queries 1-5. Query 1 1004 asks if the Exec Type Matches? The execution type for IB3 is Firm and the execution type for RS3 is Subject. Since these don't match, that information (“No”) is recorded in the second block of row 1078. No additional analysis is required between IB3 and RS3 so, in one embodiment, the analysis for this potential transaction ends at that point. In other embodiments, Query 2 1005 asks if the Price is equal to or below Order from Client IB3? In this case IB3 is willing to buy at 100.75 and RS3 is willing to sell at 100.75, so the answer again is “Yes” which is recorded in the third block of row 1078. Query 3 1006 is if it Meets Minimum Quantity? The Minimum Quantity for IB3 is 1000 and the Minimum Quantity for RS3 is 50, so the response is “Yes” which is recorded in the fourth block of row 1078. Query 5 1007 asks if there is a positive Balance of Order After Execution? Since IB3 desires to purchase 600 additional bonds and RS3 has 50 bonds to sell, the balance after the proposed transaction between IB3 and IS2 is “550”, if that transaction was allowed, so a “YES” is included in the sixth block of row 1078. Query 4 1008 asks for the greatest matching increment (if applicable). Since IB3 had an increment of 100 and RS3 has an increment of 0, the greatest matching increment is “N/A” or not applicable, so “N/A” is recorded in block 5 of row 1078. Since the answer to Query 1 is negative, this potential transaction is marked “NO TRADE”. Here, the Trade Execution Module 1000 marks “NO TRADE” in block 7 of row 1078 in the column labeled “Result: Trade, No Trade, or Partial Trade” 1009. Also recorded in row 1078 are the Execution Quantity 1010 (0), the Execution Price 1011 (0), the Cumulative Weighted Average Execution Price 1012 (0) and the Untraded Order Balance 1013 (50).

As there are no more remaining Offer Orders to evaluate, the Trade Execution Module of the ATS Interface immediately electronically notifies the Retail and Institutional ATSs that the Reserved Offer Orders have been executed, and notifies the Institutional ATS that Bid Order IB3 has resulted in a purchase of 5400 at 99.83275. As the unfilled quantity of Bid Order IB3 is now below the 1000 minimum, the balance of the order is cancelled.

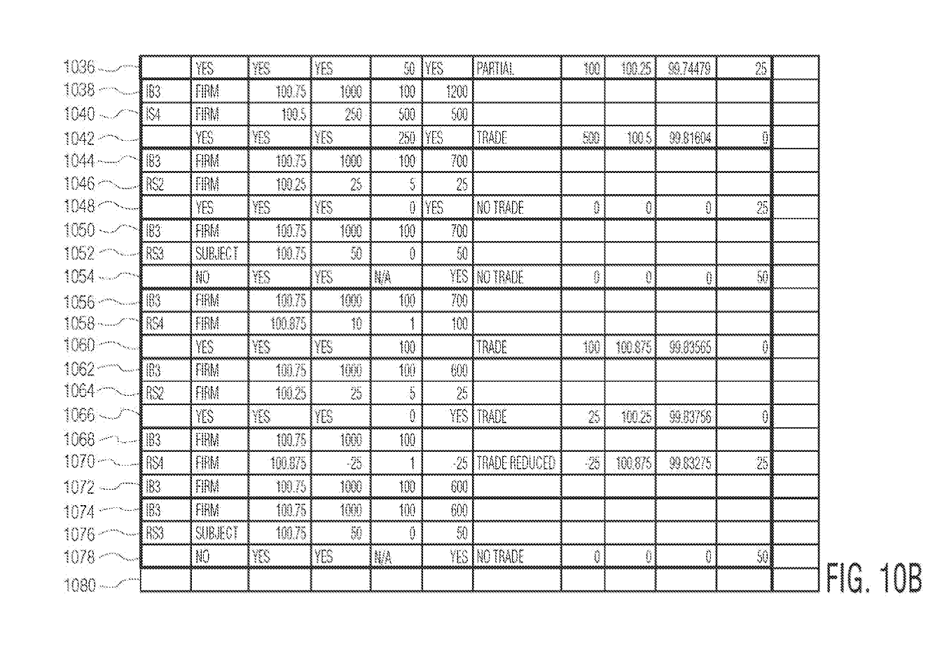

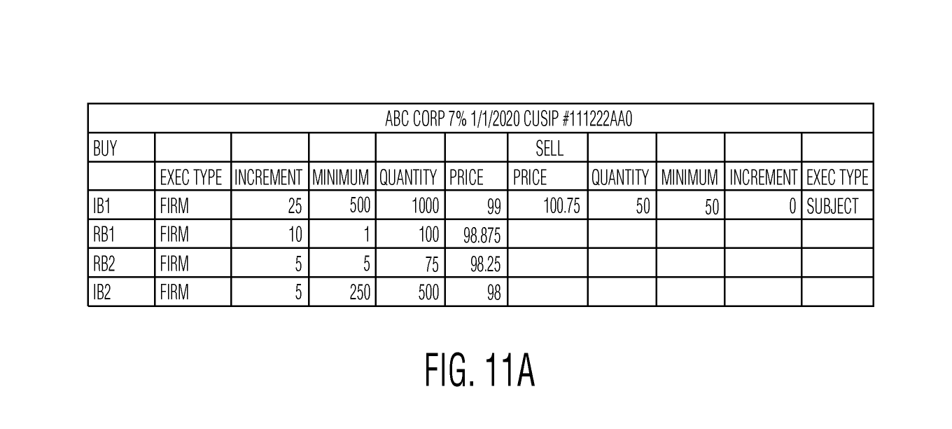

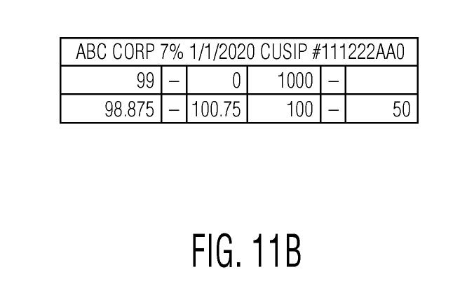

At the conclusion of the purchases of the bonds desired by IB3, the Combined Limit Order Book 940 and Two Track Quote FIG. 6, 600 are updated as shown in FIGS. 11A & B, and disseminated to market participants through market data services, such as Bloomberg.

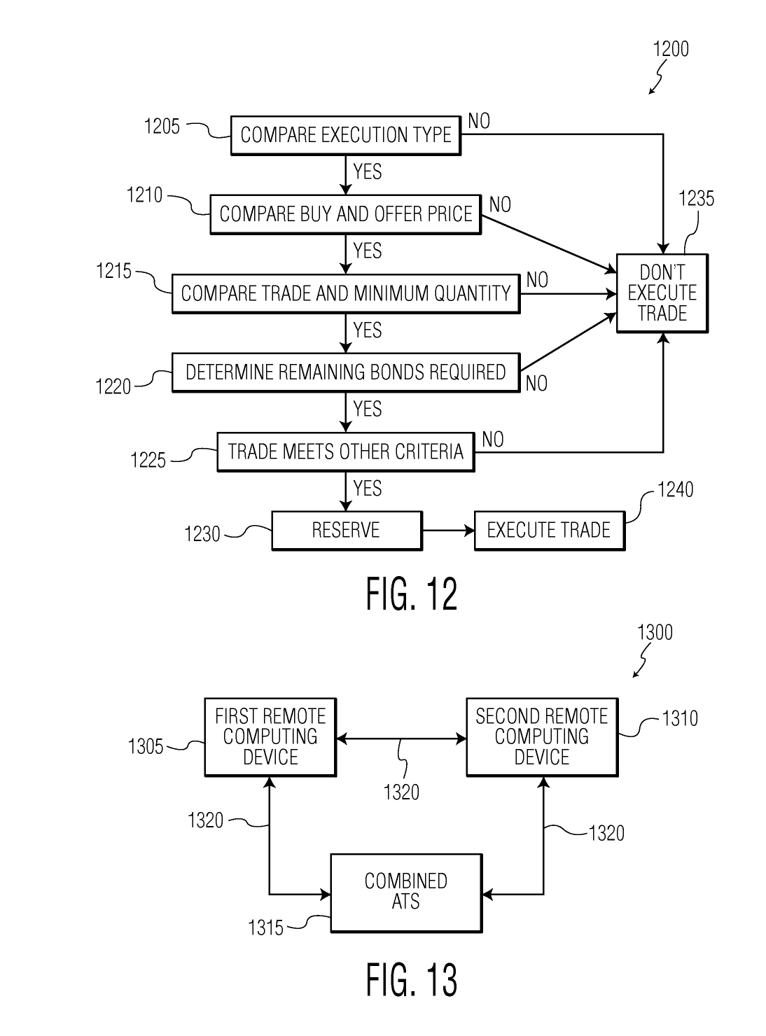

FIG. 12 shows a flow chart 1200 for the decision flow on whether to execute a trade for the Combine ATS 100. The decisions involve the inquiries of Compare Execution Type 1205, Compare Buy and Offer Price 1210, Compare Trade and Minimum Quantity 1215, Determine Remaining Bonds Required 1220, and does Trade Meet Other Criteria 1225. If all of these inquiries are affirmative, the trades are reserved in 1230. Each individual order is evaluated in price priority order, and then the orders that qualify are executed simultaneously in 1240. If one or more of the inquiries are false, the specific trade is not executed in step 1235.

FIG. 13 shows one embodiment of system including a Combined ATS. The system includes at least a first remote computer device 1305, a second remote computing device 1310, a combined ATS 1315 and communications 1320 between these components. The communications may consist of an internet, the Internet, an ethernet, a token ring, or any other system which permits the components to communicate and/or exchange data.

While the invention has been particularly shown with reference to specific embodiments, it should be understood by those of ordinary skill in the art that various changes in form and detail may be made therein without departing from the spirit and scope of the invention as defined by the claims. The invention is to cover all modifications, equivalents, and alternatives falling within the spirit and scope of the invention as defined by the claims.

1. A computer program product for financial trading, tangibly embodied in a computer readable storage device, the computer program product including instructions operable to cause a data processing apparatus to:
receive at least one retail order from a first remote computing device associated with a retail client;
receive at least one institutional order from a second remote computing device associated with an institutional client;
create a Limit Order Book in which a first record of said Limit Order Book contains information pertaining to said at least one retail order and a second record of said Limit Order Book contains information pertaining to said at least one institutional order;
organize records contained within said Limit Order Book into one of either buy order records or sell order records;
prioritize said sell order records by information contained within said sell order records;
use said prioritize sell order records to determine a first sell order record to examine;
compare information contained in said first sell order record with information contained within a selected buy order record to determine if said selected buy order record may be partially fulfilled by said first sell order record; and
execute said selected buy order record against said first sell order record.

2. The computer program product for financial trading of claim 1, wherein said at least one institutional order includes information indicating if said institutional order is a lit order or a dark order.

3. The computer program product for financial trading of claim 1, wherein said sell order records are prioritized by price.

4. The computer program product for financial trading of claim 1, wherein said sell order records are prioritized by quantity.

5. The computer program product for financial trading of claim 1, wherein information compared includes at least one of price, quantity, minimum order, increment, and execution type.

6. The computer program product for financial trading of claim 1, wherein said selected buy order record is completely fulfilled by said first sell order record.

7. A computer program product for financial trading, tangibly embodied in a computer readable storage device, the computer program product including instructions operable to cause a data processing apparatus to:
receive at least one retail order from a first remote computing device associated with a retail client;
receive at least one institutional order from a second remote computing device associated with an institutional client;
create a Limit Order Book in which a first record of said Limit Order Book contains information pertaining to said at least one retail order and a second record of said Limit Order Book contains information pertaining to said at least one institutional order;
organize records contained within said Limit Order Book into one of either buy order records or sell order records;
prioritize said sell order records by information contained within said sell order records;
use said prioritize sell order records to determine a first sell order record to examine;
compare information contained in said first sell order record with information contained within a selected buy order record to determine if said selected buy order record may be partially fulfilled by said first sell order record; and
execute said selected buy order record against said first sell order record.

8. The computer program product for financial trading of claim 7, wherein said at least one institutional order includes information indicating if said institutional order is a lit order or a dark order.

9. The computer program product for financial trading of claim 7, wherein said sell order records are prioritized by price.

10. The computer program product for financial trading of claim 7, wherein said sell order records are prioritized by quantity.

11. The computer program product for financial trading of claim 7, wherein information compared includes at least one of price, quantity, minimum order, increment, and execution type.

12. The computer program product for financial trading of claim 7, wherein said selected buy order record is completely fulfilled by said first sell order record.

13. A combined Alternative Trading System, comprising:
means for receiving at least one retail order from a first remote computing device associated with a retail client;
means for receiving at least one institutional order from a second remote computing device associated with an institutional client;
means for creating a Limit Order Book in which a first record of said Limit Order Book contains information pertaining to said at least one retail order and a second record of said Limit Order Book contains information pertaining to said at least one institutional order;
means for organizing records contained within said Limit Order Book into one of either buy order records or sell order records;
means for prioritizing said buy order records by information contained within said buy order records;
means to use said prioritize buy order records to determine a first buy order record to examine;
means to compare information contained in said first buy order record with information contained within a selected sell order record to determine if said selected sell order record may be partially fulfilled by said first buy order record; and
means to execute said selected sell order record against said first buy order record.

14. The combined Alternative Trading System of claim 13, wherein said at least one institutional order includes information indicating if said institutional order is a lit order or a dark order.

15. The combined Alternative Trading System of claim 13, wherein said buy order records are prioritized by price.

16. The combined Alternative Trading System of claim 13, wherein said buy order records are prioritized by quantity.

17. The combined Alternative Trading System of claim 13, wherein information compared includes at least one of price, quantity, minimum order, increment, and execution type.

18. The combined Alternative Trading System of claim 13, wherein said selected sell order record is completely fulfilled by said first buy order record.

19. A method for matching information contained in buy orders received with information contained in sell orders received, comprising:
receiving at least one retail order from a first remote computing device associated with a retail client;
receiving at least one institutional order from a second remote computing device associated with an institutional client;
creating a Limit Order Book in which a first record of said Limit Order Book contains information pertaining to said at least one retail order and a second record of said Limit Order Book contains information pertaining to said at least one institutional order;
organizing records contained within said Limit Order Book into one of either buy order records or sell order records;
prioritizing said sell order records by information contained within said sell order records;
using said prioritize sell order records to determine a first sell order record to examine;
comparing information contained in said first sell order record with information contained within a selected buy order record to determine if said selected buy order record may be partially fulfilled by said first sell order record; and
executing said selected buy order against said first sell order.

20. The method of claim 19, wherein said at least one institutional order includes information indicating if said institutional order is a lit order or a dark order.

21. The method of claim 19, wherein said sell order records are prioritized by price.

22. The method of claim 19, wherein said sell order records are prioritized by quantity.

23. The method of claim 19, wherein information compared includes at least one of price, quantity, minimum order, increment, and execution type.

24. The method of claim 19, wherein said selected buy order record is completely fulfilled by said first sell order record.

25. A method for matching information contained in buy orders received with information contained in sell orders received, comprising:
receiving at least one retail order from a first remote computing device associated with a retail client;
receiving at least one institutional order from a second remote computing device associated with an institutional client;
creating a Limit Order Book in which a first record of said Limit Order Book contains information pertaining to said at least one retail order and a second record of said Limit Order Book contains information pertaining to said at least one institutional order;
organizing records contained within said Limit Order Book into one of either buy order records or sell order records;
prioritizing said buy order records by information contained within said buy order records;
using said prioritize buy order records to determine a first buy order record to examine;
comparing information contained in said first buy order record with information contained within a selected sell order record to determine if said selected sell order record may be partially fulfilled by said first buy order record; and
executing said selected sell order against said first buy order.

26. The method of claim 25, wherein said at least one institutional order includes information indicating if said institutional order is a lit order or a dark order.

27. The method of claim 25, wherein said buy order records are prioritized by price.

28. The method of claim 25, wherein said buy order records are prioritized by quantity.

29. The method of claim 25, wherein information compared includes at least one of price, quantity, minimum order, increment, and execution type.

30. The method of claim 25, wherein said selected sell order record is completely fulfilled by said first buy order record.
